(19) United States
(12) Patent Application Publication
(10) Pub. No.: US 2014/0278479 A1
(43) Pub. Date: Sep. 18, 2014

(54) FRAUD DETECTION IN HEALTHCARE

(71) Applicant: Palantir Technologies, Inc., Palo Alto, CA (US)

(72) Inventors: Lekan Wang, Palo Alto, CA (US); Casey Ketterling, San Francisco, CA (US); Michael Winlo, Palo Alto, CA (US); Christopher Ryan Luck, Washington, DC (US)

(73) Assignee: Palantir Technologies, Inc., Palo Alto, CA (US)

(21) Appl. No.: 13/949,043

(22) Filed: Jul. 23, 2013

Related U.S. Application Data
(60) Provisional application No. 61/801,470, filed on Mar. 15, 2013.

(51) Int. Cl. G06F 19/00

(52) U.S. Cl. CPC G06F 19/328
USPC 705/2

(57) ABSTRACT

A system for, among other purposes, detecting health care fraud, comprises a data import component for importing health care data from data source(s) such health care providers, insurers, or pharmacies; data repositor(ies) in which the data import component creates health care objects such as provider objects that describe health care providers, patient objects that represent health care recipients, and health care event objects that describe one or more of: health care claims, prescriptions, medical procedures, or diagnoses; a correlation component that identifies correlations between the health care objects; a graph generator component that generates graphs of networks identified based at least on the correlations identified by the correlation component, the graphs comprising linked nodes that represent health care objects in the identified networks; and an interface generator that generates interfaces that display the graphs generated by the graph generator.

### BENEFIT CLAIM

This application claims the benefit under 35 U.S.C. §119(e) of Provisional Application 61/801,470, filed Mar. 15, 2013, the entire contents of which are hereby incorporated by reference as if fully set forth herein.

### TECHNICAL FIELD

The present invention relates to data processing techniques for fraud detection in the context of health insurance.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Healthcare fraud accounts for an estimated $60-80 billion dollars/year in waste. Some estimate that the damages constitute 3-10% of all healthcare expenditures. One source of fraud is prescription drug fraud. Examples of prescription fraud include forging prescriptions, altering prescriptions, stealing prescription pads, calling in prescriptions or using online pharmacies, doctor/pharmacy shopping (for example, going to multiple doctors, emergency rooms, or pharmacies and seeking prescriptions while faking symptoms such as migraine headaches, toothaches, cancer, psychiatric disorders, and attention deficit disorder, or having deliberately injured oneself), going across state lines to seek fulfillment at multiple pharmacies, refilling prescriptions before ninety days, and so forth. Prescription fraud primarily occurs at retailer pharmacies, and primarily with narcotics, anti-anxiety medications, muscle relaxants, and hypnotics.

Other sources of fraud include insurance claims fraud such as a provider charging more than peers for services, a provider billing for more tests per patient than peers, a provider billing for unlikely or unnecessary medical procedures, upcoding of services or billing for the most expensive of options, upcoding of equipment or billing for a more expensive item and delivering a lower cost item, consistently billing for high cost medical equipment, such as Durable Medical Equipment, billing for procedures or services not provided, filing duplicate claims that bill for the same service on two separate occasions, unbundling a group of services so that the services billed one at a time yield more compensation than if they had been bundled together, kickbacks from referrals, transportation fraud, collecting money from multiple insurance providers, using surgical modifiers to increase reimbursement, fraud involving viatical health and life insurance, nursing home fraud such as lack of services rendered or services rendered by non-licensed professionals, and so forth.

### SUMMARY OF THE INVENTION

The appended claims may serve to summarize the invention.

### BRIEF DESCRIPTION OF THE DRAWINGS

In the drawings:

FIG. 1 illustrates an example graph of nodes that represent data objects;

FIG. 2 illustrates an example timeline for displaying information such as the information from the graph in FIG. 1 in a manner that highlights when events occurred;

FIG. 3 shows an example composite representation that includes a graph and a timeline that are concurrently displayed;

FIG. 4 illustrates an example process for graphically arranging and utilizing information about member(s) that are related to suspect doctor(s);

FIG. 5 illustrates an example process for graphically arranging and utilizing information about doctor(s) that are related to suspect member(s);

FIG. 6 illustrates a flow for automatically identifying leads through metrics generated using data organized in accordance to a health care data model;

FIG. 7 illustrates a flow for investigating health care fraud lead using a graph-based interface that visually depicts a network of entities associated with the lead;

FIG. 8 illustrates another graph in which a node representing a particular patient object is connected by various edges to pharmacy nodes representing pharmacy objects;

FIG. 9 illustrates an example system in which the techniques described may be practiced; and

FIG. 10 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### 1.0. General Overview

In an embodiment, a system of one or more computing devices is utilized for, among other purposes, detecting health care fraud. The system comprises a data import component for importing health care data from one or more data sources, the data sources including one or more of health care providers, insurers, or pharmacies; one or more data repositories in which the data import component creates health care objects representing the health care data in accordance to a defined ontology, the health care objects including provider objects of one or more provider object type that describes health care providers, patient objects of one or more patient object types that represent health care recipients, and health care event objects of one or more event object types that describe one or more of: health care claims, prescriptions, medical procedures, or diagnoses; a correlation component that identifies correlations between the health care event objects, the provider objects, and the patient objects; a graph generator component that generates graphs of networks identified based at least on the correlations identified by the correlation component, the graphs comprising linked nodes representing particular health care objects in the identified networks, including particular patient nodes representing particular patient objects and particular provider nodes representing particular provider objects; and an interface generator that generates interfaces that display the graphs generated by the graph generator.

In an embodiment, the system further comprises an object presentation component for generating presentations of particular health care objects to display in the interfaces. In an embodiment, the system further comprises an input handler for receiving inputs selecting particular controls associated with particular nodes in graphs displayed in the interfaces; and an object presentation component for generating presentations of information about particular objects associated with particular nodes selected by the inputs. In an embodiment, the system further comprises: a filtering component that identifies networks for the graph generator to graph; and an input handler for receiving inputs selecting particular controls associated with particular nodes in graphs displayed in the interfaces. The filtering component is configured to identify networks related to particular nodes selected by the inputs.

In an embodiment, the system further comprises: a filtering component that identifies networks for the graph generator to graph; and a metric calculator configured to calculate metrics associated with the health care objects based at least on the identified correlations; a lead identifier component configured to identify health care objects that are leads for fraud investigations based at least on the calculated metrics. The filtering component is configured to identify networks related to the health care objects that are leads for fraud investigations. In an embodiment, the system further comprises a metric calculator configured to calculate metrics associated with the health care objects based at least on the identified correlations; wherein the interface generator is configured to depict different nodes and/or different edges in the graphs differently based on the calculated metrics.

In an embodiment, the system further comprises a workflow module that accepts inputs, generated by one or more of users or an automated lead identifier component, that identify particular health care objects as leads for fraud investigations, the workflow module further configured to generate workflow tickets based on the inputs and send the workflow tickets to analyst for further investigation. In an embodiment, the one or more data repositories further store pharmacy objects of a pharmacy object type that describes pharmacies; wherein the linked nodes include one or more pharmacy nodes that represent one or more pharmacy objects. In an embodiment, the system further comprises a mapping component for generating maps of health care events correlated to particular health care objects represented in particular graphs. In an embodiment, the linked nodes in the graphs generated by the graph generator are connected by edges representative of relationships, wherein at least some of the relationships are derived from health care event objects based on the correlations. In an embodiment, the components of the system further provide other functionality as described herein.

In an embodiment, a method performed by the various systems described herein comprises: generating provider objects that describe health care providers; generating patient objects that describe health care recipients; identifying relationships between the health care event objects, the provider objects, and the pharmacy objects; based on the relationships, identifying a network of one or more provider objects and the one or more patient objects; generating a graph of the network, the graph comprising linked nodes, the linked nodes including one or more patient nodes that represent the one or more patient objects and one or more provider nodes that represent the one or more provider objects. In an embodiment, the method further comprises generating pharmacy objects that describe pharmacies; wherein the linked nodes include one or more pharmacy nodes that represent one or more pharmacy objects. In an embodiment, the method further comprises generating health care event objects that describe health care events. The linked nodes include: one or more event nodes that represent one or more health care event objects; or one or more edges that represent one or more health care event objects.

In an embodiment, a method comprises: generating provider objects that describe health care providers; generating patient objects that describe health care recipients; generating health care event objects that describe one or more of: health care claims, prescriptions, medical procedures, or diagnoses; correlating the health care event objects to the provider objects and the patient objects; receiving input specifying a particular object, wherein the particular object is one of a particular provider object or a particular patient object; based on the correlating, identifying a network of one or more provider objects and one or more patient objects that are associated with the particular object; and generating a graph of the network, the graph comprising linked nodes, the linked nodes including one or more patient nodes that represent the one or more patient objects and one or more provider nodes that represent the one or more provider objects.

In an embodiment, generating the health care event objects comprises generating a separate health care event object from each log entry in one or more logs collected from one or more of: a provider data source, an insurer data source or a pharmacy data source. In an embodiment, the method further comprises: generating fraud objects representing known instances of health care fraud; and linking a particular provider node or a particular patient node to a fraud node within the graph, the fraud node representing a particular fraud object. In an embodiment, the health care event objects include at least objects of a prescription event type, objects of a medical claim event type, and objects of a diagnosis event type. In an embodiment, the method further comprises generating pharmacy objects that describe pharmacies. The linked nodes include one or more pharmacy nodes that represent one or more pharmacy objects.

In an embodiment, the method further comprises: correlating multiple objects of different types to a single entity, the multiple objects comprising one or more of the provider objects or the patient objects; and representing the multiple objects within the graph as one of: a single node representing a logical object that corresponds to a merger of the multiple objects, or as multiple nodes linked to each other by one or more relationships.

In an embodiment, the correlating further comprises deriving relationship constructs based on the health care event objects. The relationship constructs define links between the provider objects and the patient objects. In an embodiment, the graph comprises one or more edges that depict links between particular linked nodes, the edges representing one or more of the relationship constructs. In an embodiment, the one or more edges comprise a first edge that graphically represents a first relationship type and a second edge that graphically represents a second relationship type. In an embodiment, the one or more edges graphically depict a summary of particular health care event objects from which the one or more of the relationship constructs were derived.

In an embodiment, the method further comprises: computing values of metrics associated with the provider objects and metrics associated with the patient objects based at least in part on the correlating. In an embodiment, the method further comprises depicting, within the graph, one or both of the linked nodes or edges linked the linked nodes differently based on the computed values. In an embodiment, the method further comprises generating a visualization of the values. The particular object is selected in part based on a selection of a particular value, calculated in association with the particular object, from the visualization. In an embodiment, the method further comprises comparing the values to defined triggers that define thresholds for unusual values; and selecting the particular object at least partly responsive to the particular object being associated with a particular metric value that has an unusual value according to a particular defined trigger. In an embodiment, the method further comprises determining the size of the network based at least in part on the metric values. In an embodiment, the particular object is selected based in part on a metric value associated with the particular object that indicates one or more of: a doctor writing significantly more prescriptions than normal; a sudden increase in prescriptions filled by a patient who was not previously filling many prescriptions, a patient receiving a significant amount of emergency room visits in a specific time period; a patient receiving prescriptions from more than a certain number of providers within a certain time period.

In an embodiment, the network comprises an object that represents a particular practitioner, objects that represent patients who have had prescriptions written by the particular practitioner, and objects that represent other practitioners that those patients have visited. In an embodiment, the network comprises an object that represents a pharmacy customer, objects that represent pharmacies visited by that pharmacy customer, objects that represent pharmacists employed at the pharmacies, and objects that represent instances of fraud associated with the pharmacists or pharmacies.

In an embodiment, the method further comprises presenting the graph as part of an interactive interface for investigating health care data, the interface embedding a control for selecting at least a particular linked node; and generating a presentation comprising data associated with a first object that the particular linked node represents responsive to selection of the control, the presentation including one or more of: a list or timeline of data from health care event objects correlated to the first object, aggregated statistics calculated in association with the first object, demographic information associated with the first object, or a map depicting locations and/or health care events related to the first object.

In an embodiment, the method further comprises presenting the graph as part of an interactive interface for investigating health care data, the interface embedding a control for selecting a particular edge between particular linked nodes; and generating a presentation of data associated with one or more particular relationships that the particular edge represents responsive to selection of the control, the one or more particular relationships derived from particular health care event objects, the presentation including one or more of a list of the particular health care events or a map of the particular health care events.

In an embodiment, the method further comprises presenting the graph as part of an interactive interface for investigating health care data, the interface embedding a control for selecting a particular linked node; and responsive to selection of the control, flagging a first object associated with the particular linked node for subsequent investigation and generating a workflow ticket identifying the first object as a lead.

In an embodiment, a method comprises generating health care event objects that describe one or more of: health care claims, prescriptions, medical procedures, or diagnoses; generating provider objects that describe health care providers; generating patient objects that describe health care recipients; generating pharmacy objects that describe pharmacies; correlating the event objects to the provider objects, the member objects, and the pharmacy objects; computing metrics for the provider objects, the member objects, and the pharmacy objects based on the correlating; identifying unusual metric values in the metrics; and identifying lead objects for investigation based on the unusual metric values, wherein the lead objects include one or more of: a particular provider object, a particular pharmacy object, or a particular patient object.

### 2.0. Structural Overview

FIG. 9 illustrates an example system 900 in which the techniques described may be practiced, according to an embodiment. System 900 is a computer-based system. The various components of system 900 are implemented at least partially by hardware at one or more computing devices, such as one or more hardware processors executing instructions stored in one or more memories for performing various functions described herein. System 900 illustrates only one of many possible arrangements of components configured to perform the functionality described herein. Other arrangements may include fewer or different components, and the division of work between the components may vary depending on the arrangement.

System 900 comprises a data import component 915 which collects data from a variety of sources, including one or more of provider sources 911, insurer sources 912, public sources 913, and other sources 914 as described herein. The data may be collected from each source 911-914 on one or on multiple occasions, depending on factors such as the size of the data source, the accessibility of the data source, and how frequently the data source changes. Depending on the form in which the data is collected, the data import component 915 may option perform Extract, Transform, and Load (“ETL”) operations on the collected data to generate objects that conform to one or more defined ontologies 990. Ontologies 990 may be, for example, dynamic ontologies, static schemas, and/or other data structure definitions.

The data import component 915 causes the collected data to be stored in one or more repositories of data 920. The one or more repositories of data 920 may store, among other object types, some or all of: provider objects 921, patient objects 922, pharmacy objects 923, health care event objects 924, and other objects 925, each of which corresponds to a different discrete object type defined by the one or more ontologies 990. Other objects 925 may include any category of object type deemed desirable. For example, another object type may be administrative event objects. Thus, in an embodiment, data obtained from healthcare providers, insurers, public sources and other sources may be represented in computer storage using object-oriented data representation techniques to represent providers, patients, pharmacies, events, and other items as objects capable of connection in a graph based on real-world relationships, events or transactions. Examples of repositories 920 and corresponding objects 921-925 are described in subsequent sections.

System 900 comprises a correlation identification component 930 that correlates objects 921-925, in accordance to the techniques set forth herein. Correlations produced by correlation identification component 930 are used by a graph generator 940 to produce object graphs, in accordance with the techniques described subsequently. The graphs describe relationships between various networks of objects 921-925, which may be based at least in part on the correlations.

Graphs produced by graph generator 940 are provided to an interface generator 960, which generates visual presentations of the graphs to display to a user in an interface 965. The visual presentations of the graphs depict various objects 925, and the relationships between those objects. Accordingly, an object presentation generator 945 generates various presentations of objects. These object presentations are used in the visual presentations generated by interface generator 960. Examples of such visual presentations, both of graphs and of objects, are provided in subsequent sections.

To assist a user in navigating and understanding the graphed data, a filtering component is coupled to graph generator 940. Filtering component 950 reduces, simplifies, filters, or otherwise manipulates the networks of objects and relationships depicted by the graphs, in accordance with the techniques described subsequently. The filtering component 950 may act in response to various inputs received via an input handler 970, which receives input associated with various controls embedded within the visual presentations displayed in interface 965. Examples of such input are described subsequently.

A metric calculator 935 calculates various metrics based on objects 921-925 and/or other data. Correlations produced by correlation identification component 930 may further be used to generate some of these metrics. Example metrics are described in other sections. The metrics may be used for a variety of reporting purposes. For example, object presentation generator 945 and/or interface generator 960 may utilize the metrics to adjust the visual presentations of the graphs and/or the objects shown within.

Certain relationships and/or correlations of objects may suggest fraudulent activity. In an embodiment, an optional lead identification component 980 identifies “leads” for suspected fraudulent activity, in accordance with the techniques described subsequently. The leads may be, for example, particular objects within repositories 920 or relationships of plural objects. The leads may be identified based on metrics values calculated by metric calculator 935 and deemed to be unusual or out-of-pattern based on various fraud detection or pattern recognition processes. The leads may be fed to the filtering component 950, which manipulates the graph to draw attention to the identified lead(s), in accordance with the techniques described subsequently.

### 3.0. Functional Overview

Techniques are described herein for modeling data related to health care and using the models in combination with detection processes to identify fraud. In general, the techniques described herein utilize data obtained or extracted from various sources of health care data. The data are then transformed into various stored data objects, relationships and graphs that conform to a common model for health care data, such as a dynamic ontology or schema. The data types defined by the common model provide for at least: one or more data objects describing patients and/or health care plan members, one or more data objects describing health care providers and/or individual doctors, and one or more data objects describing health care events such as prescriptions, claims, treatments, and/or procedures. In embodiments, other data objects describing a variety of other health care entities, places, and events also exist. Various examples are described herein.

3.1. Fraud Investigations

Embodiments are useful for a number of different fraud-related purposes. In an embodiment, the data objects are used at various points of a four-stage workflow for identifying fraud. The first stage is lead generation. This stage involves identifying suspected cases of health care fraud for further investigation. A lead, as described herein, is a particular individual, organization, or event that is suspected as consisting of, relating to, or indicating actual or possible fraud, or is at an increased probability for consisting of, relating to, or indicating fraud. The term lead may also be used herein to refer to a data object that represents the suspicious individual, organization, or event. One way to identify leads is to receive tips concerning potentially fraudulent activities. Another way to identify leads is to review networks of individuals and/or organizations connected to instances of fraud described in media reports, indictments, or other publications. Another way to identify leads is to apply business rules to the various data objects and relationships described herein to flag potentially fraudulent activity, such as a male receiving treatment for ovarian cancer. Another way to identify leads is to deploy computer-implemented algorithms and/or analytical processes that calculate metrics based on the various data objects described herein, such as a metric that indicates the number of prescriptions written by each doctor for commonly abused drugs. Data objects associated with unusual values for these metrics may be investigated as leads.

The next stage is lead prioritization. There may be many possible leads to investigate, but limited resources to investigate such leads; lead prioritization enables focusing limited resources on the leads that are given higher priority. Lead prioritization may comprise, for instance, filtering the set of leads based on one or more of: which leads involve certain types of fraud, which leads involve at least a certain threshold amount of money, which leads constitute the most obvious cases of fraud, which leads are easiest to investigate, or which leads are closely clustered. In an embodiment, various metrics that consider these and/or other factors may be used to rank the leads, and the leads may then be investigated in order of rank. In an embodiment, two primary metrics for ranking leads are configured to quantify likeliness of fraud, and impact of fraud if fraud has in fact occurred. However, a variety of other metrics for ranking leads may be created. Different investigators may be responsible for investigating leads prioritized based on different factors or metrics.

The next stage is investigation of a prioritized lead. During this stage, an investigator may seek answers to questions such as, to whom are the implicated doctors prescribing, who picks up the prescriptions involved, what medical treatments are the doctors performing, are any of those medical treatments suspect, with what larger network of other providers do the suspects interact, are any of the other providers suspect, do the providers refer other people who then prescribe drugs that are not supposed to be prescribed based on the facts involved, and so forth. In an embodiment, various data visualization and interfacing techniques for depicting the data objects described herein simplify this investigation. For example, networks of doctors, patients, and pharmacies may be depicted as navigable graphs of interconnected nodes, in which the connections are determined based on various health care events.

The fourth stage is to take action upon a positive investigation of a lead. For some patients, for example, this may involve making an intervention such as providing treatment for addiction or depression. For other patients, and for fraudulent providers, the action may involve turning over findings to an insurer and/or to law enforcement.

The above workflow is provided as an example. Other workflows for investigations of fraud may include different elements in varying arrangements. The data objects described herein are likewise useful in these other workflows.

3.2. Automated Identification of Leads Through Metrics

FIG. 6 illustrates a flow 600 for automatically identifying leads through metrics generated using data organized in accordance to a health care data model, according to an embodiment. In an embodiment, each of the processes described in connection with the functional blocks of FIG. 6 may be implemented using one or more computer programs, other software elements, and/or digital logic in any of a general-purpose computer or a special-purpose computer, while performing data retrieval, transformation and storage operations that involve interacting with and transforming the physical state of memory of the computer.

Block 610 comprises generating provider objects that describe different health care providers. Data for the provider objects may be obtained, for example, from claims submissions of providers to insurers, who then provide the data to a computer system that implements the techniques herein. A health care provider may be any entity that provides health care services. Health care providers may include organizational entities, also referred to as facilities or institutions, such as hospitals and clinics. Health care providers may also include individual practitioners, also referred to as health care workers, such as doctors and dentists. In some cases, such as in the case of solo practitioners, an individual practitioner may also function as an organizational entity.

In an embodiment, there are different types of provider objects that represent individual practitioners as opposed to organizational entities. In an embodiment, different types of provider objects may comprise data collected concerning the same providers from different sources. In an embodiment, different types of provider objects may comprise data collected concerning the same providers while those providers are functioning in different roles. For example, a single doctor may correspond to a prescriber object that stores data collected concerning the doctor while in his capacity as a prescriber of drugs, one or more specialist objects that store data collected concerning the doctor while in his capacity to perform certain specialized procedures or evaluations, and/or a practitioner object that represents data collected from the doctor while in his role as a provider generally. Alternatively, a doctor may be represented by a prescriber object, and then associated with a facility object for a facility at which the doctor is employed. In an embodiment, there may be only one type of provider object, and all data related to all of the roles of a doctor/practitioner may instead be collected under the umbrella of this single type of provider object.

Block 620 comprises generating patient objects that describe recipients of health care. In an embodiment, different types of patient objects may comprise data collected concerning the same providers from different sources. For example, a single person may be represented by a member object comprised of data collected by an insurer that sponsors a health plan of which the person is a member, but also be represented by separate patient objects comprised of data collected in association with different providers, and/or customer objects comprised of data collected from a pharmacist. In an embodiment, different types of patient objects do not necessarily correlate to sources, but rather to roles associated with a patient when data is collected, such as a plan member, or a pharmacist customer. In an embodiment, data related to all of the roles of a patient may instead be collected under the umbrella of a single type of patient object.

Block 630 comprises generating health care event objects that describe one or more of: health care claims, prescriptions, medical procedures, or diagnoses. For example, an event object may be generated for each log entry in one or more logs from providers, insurers, and/or pharmacies, or based on claims submissions to insurers. There may be multiple types of event objects for some or all of claims, prescriptions, procedures, and diagnoses. For example, there may be different event object types for medical claims and prescription claims. Or, there may be a single event object type comprising a type field that classifies each event. Other event types may also be modeled, such as instances of fraud. Different embodiments may feature different combinations of events.

Block 640, which may be optional in some embodiments, comprises generating pharmacy objects that describe pharmacies. Depending on the embodiment, there may be different types of pharmacy objects to represent different types of pharmacies. Data for pharmacy objects may be obtained directly from pharmacies or their owners, or from claims data of insurers.

Block 650 comprises correlating event objects to provider objects, patient objects, and/or pharmacy objects. For convenience, the term entity may subsequently be used to refer to any one of a provider, patient, or pharmacy, and the term entity object may thus be used to refer to any object comprising data that represents such an entity. Each correlated event object is resolved to at least one of the provider objects, patient objects, or pharmacy objects (if generated) by comparing one or more attributes of the event object, such as an identifier of an entity involved in the event, to corresponding attribute(s) of the provider objects, patient objects, or pharmacy objects. For example, a prescription event object may comprise fields that identify objects representing the practitioner who wrote the prescription, or an associated facility. As another example, a claim event may comprise fields that identify a member object and a facility object.

In embodiments where different types of provider objects and/or patient objects may exist for the same entity, block 650 may also comprise correlating those objects using any suitable entity resolution technique. For example, a practitioner object may be correlated to a prescriber object using a government identifier, or a unique combination of attributes such as name, location, and age. Once objects have been correlated to a same entity, a unique system identifier for the entity may be created, and added as an attribute to each object correlated to that entity. For the purposes of the subsequent analyses, objects resolved to a single entity may be temporarily merged into one or more logical provider or patient objects. Or the objects may remain separated, but linked to each other by relationships.

A relationship is a data construct that links two or more objects in association with a defined relationship type. In an embodiment, block 650 further comprises generating relationships based on the correlating. At least some of the event objects may be correlated to multiple entity objects. For example, a prescription object may be correlated both to the prescriber object representing the doctor who wrote the prescription, and a patient object representing the patient for whom the prescription was written. The event objects may thus be used to derive relationships between entities that reflect services rendered by a first entity in the relationship on behalf of a second entity in the relationship, such as “wrote a prescription for” or “filled a prescription at” or “received a diagnosis at.” In an embodiment, a relationship may further include attributes that link the relationship to specific event(s) from which the relationship was derived and/or that count the number of associated events.

Block 660 comprises computing values of metrics associated with the provider objects, the patient objects, and the pharmacy objects, based on the correlating. A first example type of metric for a particular entity object involves counting correlated event objects of certain types and/or that have certain qualities. A second example type of metric involves summing or averaging certain attributes of certain types of correlated event objects and/or of correlated event objects having certain qualities. A third example type of metric involves computing standard deviations for other metric values across groups of entities and/or geographic areas. A fourth example type of metric involves calculating various functions of certain attributes of certain correlated event objects. A fifth example type of metric involves calculating the percentage of correlated event objects of a certain type that have certain attribute value(s). A variety of other types of metrics of varying complexity are also possible. For example, various metrics may be formulated to attempt to identify any of the fraudulent behaviors described herein.

Some metrics may be time-sensitive. For example, some metrics may pertain to events of a recent time period such as the last month or year, while others may pertain to designated time periods such as Q3 2007. The metrics for a particular entity may also be based on metrics or attributes associated with entities to which the particular entity is related. For example, a metric for a practitioner may count the number of the practitioner's patients who have a certain quality such as a history of drug abuse.

Block 670 comprises identifying a set of unusual metric values. The identifying may comprise, for example, identifying individual values for a metric that are outside of a certain number of standard deviations for that metric, or values for the metric that are over or under a threshold value for the metric. The identifying may also or instead comprise ranking individual values for a metric by how much they vary from an average value for the metric, and selecting a certain number of the values having a highest variance. Unusual combinations of metric values, where no single metric value by itself would be unusual, may also be identified. Other pattern recognition techniques, such as those based on transaction histories or heuristics, may be used to identify out-of-pattern values for metrics.

In an embodiment, the identifying is automated. Certain pre-defined metrics are monitored and associated with triggers. When any individual value for a monitored metric reaches a threshold defined by the trigger, the trigger identifies the value as being unusual. The monitoring may be ongoing, or the monitoring may occur at various intervals or upon request. In an embodiment, rather than monitoring predefined metrics for unusual values, various algorithms are trained to locate unusual values. In an embodiment, different users may define different types of triggers. For example, a prescription fraud specialist may define triggers to examine metrics indicative of possible prescription fraud, whereas a claims fraud specialist may define triggers related to claim fraud.

In an embodiment, the identifying is done manually, by personnel trained to look for unusual values. To assist such personnel, an analysis application may provide various visualizations of various metrics. For example, the application may present histograms for various metrics, from which the personnel may select values in a long tail.

In an embodiment, the identifying may be based on context-sensitive risk scores that take into account factors such as geographies, hospitals, physicians, patients, and so forth. For example, certain values for certain metrics may be more alarming in the context of states whose laws do not regulate drugs closely than in the context of other states. Or, changes in certain metrics may be more alarming for specific entities that are linked to past instances of fraud than the changes would otherwise be. Thus, to ensure that metrics are considered in view of the overall risk that the metrics actually suggest, certain metrics may be weighted by or otherwise adjusted based on risk scores. Risk scores may be entered manually, linked to certain types of attributes and/or events, and/or learned through various feedback mechanisms over time.

Specific examples of unusual metric values could include, without limitation: a doctor writing significantly more prescriptions than normal, based on her own historical averages, or more than her peers on average; a sudden significant spike in prescriptions filled by patients who were not previously filling many prescriptions, patients receiving a significant amount of emergency room visits in a specific time period, such as 45 visits in five days; patients receiving prescriptions from more than a certain number of providers within a certain time period, such as five different prescriptions from five different providers; providers who do not file claims.

Block 680 comprises, based on the unusual metric values, identifying one or more lead objects for investigation. The lead objects are those for whom the unusual metric values were calculated. The lead object(s) include one or more of: a particular provider object, a particular pharmacy object, or a particular member object. The lead objects may not necessarily include objects selected based on all of the identified unusual metric values. For example, certain potential lead objects may be filtered based on business rules. Or, the potential lead objects may be filtered based on a ranking process to prioritize an investigation.

In an embodiment, a lead object is flagged within a database, and an investigative analyst may later look for any objects that have been flagged. Different objects may be flagged differently to indicate that they should be investigated by an investigator having different specialties. For example, different object types and/or unusual metric values may be better suited for investigation by different types of analysts. In an embodiment, an email identifying lead objects may be generated. Any other suitable mechanisms may be used for identifying the lead objects to analysts. In an embodiment, blocks 670-680 occur in response to a request from an analyst to an analysis module. The analysis module visually reports the leads in a user interface area, from which the investigator may immediately launch an investigation using techniques such as described herein.

Flow 600 is but one example technique for identifying leads through metrics generated using data organized in accordance to a health care data model. Other flows may include fewer or additional elements in varying arrangements. For example, in an embodiment, the data model further provides for provider group objects, such as provider specialty objects. Such objects may group a number of practitioners together for various reasons, such as for identifying problems within a certain specialty group at a single facility, or within a geographic area.

3.3. Fraud Events

In an embodiment, the identifying of leads is based at least in part on data mining of tips, fraud indictments, and/or news articles concerning fraud. In an embodiment, data entry personnel read such data, and then enter the names of the involved entities within the data model. Or, named entities within these sources may be parsed automatically using natural language processing techniques. For example, a data mining module may monitor an RSS feed of news articles that matches certain categories or searches, and automatically parse such articles. Or, indictments on government sites like the website of the attorney general may be collected and parsed. In any event, once named entities are identified, fraud event objects, potentially linked to corresponding publications, are generated. The fraud events may be correlated to entities per block 650. In an embodiment, some or all fraud events are used to generate leads. For example, the entity objects correlated to the fraud event objects may become leads, and related networks of entities may be analyzed according. In an embodiment, identifying leads through fraud events occurs separately from identifying leads through metrics. In other embodiments, fraud events are used to generate metrics, and/or metrics may be utilized to prioritize or filter fraud events.

3.4. Generating a Graph for Investigating Leads

FIG. 7 illustrates a flow 700 for investigating health care fraud lead using a graph-based interface that visually depicts a network of entities associated with the lead, according to an embodiment.

Block 710 comprises generating provider objects that describe health care providers, as described with respect to block 610 above.

Block 720 comprises generating patient objects that describe health care recipients, as described with respect to block 620 above.

Block 730 comprises generating health care event objects that describe one or more of: health care claims, prescriptions, medical procedures, or diagnoses, as described with respect to block 630 above.

Block 740 comprises correlating the health care event objects to the provider objects and the member objects, in similar manner to block 750 above.

Block 750 comprises generating relationships between provider objects and patient objects based at least on the event objects, in similar manner to the optional relationship building features of block 750 above.

Block 760 comprises receiving input specifying a particular object, wherein the particular object is one of a particular provider object or a particular patient object. The input may be input that selects a lead object from a list of lead objects, for example. Or the input may be input that clicks on a particular object in various presentations of information about the various data objects described herein, such as a histogram or graph of metric values, a map of providers or members, a drag and drop operation on an icon representing the particular object, and so forth. Or the input may be a search for objects matching certain criteria. The input may instead be any other input that is suitable for selecting the particular object. The input also may comprise a selection of one particular object from among a plurality of objects that are received or identified as a result of executing a search query on the database.

Block 770 comprises, based on the relationships, identifying a network of one or more provider objects and one or more member objects that are associated with the particular object. For example, block 770 may comprise identifying all entity objects that are within a certain number of relationships to the particular object. The network may constitute objects that represent, for example, a particular practitioner, patients who have had prescriptions written by the practitioner, and other practitioners that those patients have visited. Or, as another example, the network may constitute a facility, practitioners employed or formerly employed by the facility, and patients of the facility. The network may be extended to objects having any arbitrary number of relationships from the particular object. The exact extent may be configurable and modifiable by an analyst using any suitable interface techniques.

In an embodiment, a network may be filtered to contain objects connected by just certain relationship types of the possible relationships. In an embodiment, a network may be filtered to contain only objects of certain types and/or objects having certain attributes. In an embodiment, a network may be filtered to contain only objects connected to the particular object by relationships pertaining to events collected from certain dates, certain regions, or having other certain attributes in common. Again, the exact filtering performed may be configurable and modifiable by an analyst using any suitable interface techniques. For example, in an embodiment, the interface may present a menu of elements in an ontology and allow a user to select which elements to graph and/or how to graph them.

In an embodiment, the filtering and/or the network size may be determined based on metrics indicating a level of significance of certain objects and/or relationships to a particular type of fraud. For example, medical procedure-based relationships may be less significant in the context of prescription drug fraud. Thus, if the particular object was flagged as a lead for drug fraud, medical procedure-based relationships may be filtered, or at least limited in extent to a small number of degrees. In an embodiment, groups of less significant objects may be collapsed into a single node or relationship within the network, from which they may be subsequently be separated if so requested by a user.

Block 780 comprises generating a graph of the network comprising linked nodes. In some embodiments, block 780 also may comprise causing the graph to be displayed visually in a graphical user interface of a computer display device. The linked nodes include one or more patient nodes that represent the one or more patient objects and one or more provider nodes that represent the one or more provider objects. The nodes may represent their respective objects using any suitable technique. For example, patient nodes may be depicted with a person icon, facility nodes with a building icon, practitioner nodes with a doctor icon, and so forth. The representation of a node may further or instead include various attributes selected from the corresponding object, such as name, gender, age, location, picture, metric values, and so forth. The graph further includes representations of the relationship(s), or edge(s), between each object. There may or may not be different types of edges for different types of relationships. For example, in an embodiment, all relationships are represented with but a single line, where in other embodiments, multiple different lines would be shown. The edges may or may not contain a label identifying the type(s) of relationship(s). The edges also may or may not contain a quantity indicator indicating the number of events based upon which a relationship was generated. Edges may be color-coded or otherwise differentiated based on relationship type.

Various highlighting techniques may be utilized to emphasize nodes corresponding to objects for which there is an unusual metric. For example, a red circle may be drawn around providers with a history of fraud. As another example, facilities where an unusual number of certain types of prescriptions are written may be represented with larger icons than other facilities. Highlighting techniques may also be used to emphasize or deemphasize certain nodes or edges based on relationship strengths. For example, the strength of a relationship between a provider object and a patient object may be reflected in the width of a line connecting the corresponding provider node and patient node. Or, patients with whom the particular provider has only once interacted may be shown using a much smaller icon than patients with whom the particular provider has frequently interacted.

In an embodiment, the graph of block 780 is presented as part of an interactive interface for investigating health care data. The interface may embed a variety of controls within the graph that are activated by selecting various graph elements, including the nodes and edges. An analyst may use the controls, for instance, to manipulate the presentation of information in order to search for and/or investigate the types of fraud described herein.

One particular interface action is selecting a graph node or edge to drill-down into information about the object(s) represented by the node or edge. In an embodiment, block 790 comprises, optionally, generating a presentation based on values from and/or metrics related to a first object represented by a first node selected from the graph by first input. The presentation may be provided in any suitable location, including in a popup window, in a separate tab or area of the interface, or on a separate screen. The presentation may include any data values or metrics associated with the first object. For example, the information may contain a list or timeline of events correlated to the first object, aggregated statistics for the first object, demographic information, a map, graphs, and so forth. In an embodiment, the first input may select multiple objects, and the presentation contains information for the multiple objects, such as averaged or summarized statistics, maps depicting locations and/or events related to all of the selected objects, and so forth.

In an embodiment, input may select an edge from the graph. A presentation of information about event(s), such as a list of events or map of events, is generated. In an embodiment, the interface features controls for navigating through the graph, zooming in or out of the graph, and/or filtering or extending the network covered by the graph. In an embodiment, the interface is configured to change emphases and highlighting based on a currently selected element of the graph. For example, a patient node that is only loosely related to the particular node may be small initially, but then may grow in response to the user selecting a different node in the graph with which the patient node is more clearly related.

A variety of other techniques for generating an interactive graph-based interface may also be utilized. Examples of such interfaces are described in, for example, U.S. Ser. No. 13/247,987, filed Sep. 28, 2011, and U.S. Ser. No. 13/669,274, filed Nov. 5, 2012, describe various examples of interactive graph-based interfaces. The entire contents of both applications are hereby incorporated by reference for all purposes as set forth in their entirety herein.

Flow 700 is but one example of techniques for identifying leads through metrics generated using data organized in accordance to a health care data model. Other flows may include fewer or additional elements in varying arrangements. For example, in an embodiment, the correlating and graphing may involve other types of nodes, such as nodes representing pharmacy objects, publication objects, drug objects, medical procedure objects, owner objects, employee objects, pharmacist objects, and so forth.

In an embodiment, certain event-based relationships connect entity objects indirectly, by means of event objects. For example, a prescriber object may have a relationship to an event, and the event may have a relationship to a patient object. In such an embodiment, events may themselves be represented as nodes in the graph. Or, the combination of the event and the relationships connecting two entity objects to the event may be abstracted into a single relationship represented by a single edge. In an embodiment, a user may switch in between the two representation styles. In an embodiment, any arbitrary chain of relationships and objects may be temporarily reduced to a single relationship for purposes such as presentation in a graph and/or calculation of metrics.

Other embodiments may comprise performing the above steps with any arbitrary combination of different entity types, based on any arbitrary set of event types, regardless of whether the entity types and/or event types include those specifically stated above.

In an embodiment, the interface may feature various controls optimized for certain types of investigative tasks, such as verification of provider/facility details, screening for histories of investigative actions, reviewing claims in the source data, verifying member status, searching for related entities, determining a likelihood that a doctor is actually participating in fraud based on factors such as has the doctor recently had their DEA number stolen, and so forth.

In an embodiment, the particular object is a provider that has been charged with fraud, and the network includes a plurality of former patients of the provider and their new providers. In an embodiment, relationships may also be based on data such employer-employee status, ownership, likely relationships, co-residency, familial relationship, social networks, and so forth.

### 4.0. Data Architecture

In an embodiment, the health care event objects are maintained in a health care event repository comprising one or more databases that store the health care event objects, the provider objects are maintained in a provider repository comprising one or more databases that store the provider objects, the patient objects are maintained in a patient repository comprising one or more databases that store the patient objects, and the pharmacy objects are maintained a pharmacy repository comprising one or more databases that store the pharmacy objects. Other repositories may exist for other types of data objects. The one or more databases that constitute a repository may overlap between some or all of the repositories. Or, the repositories may be maintained separately.

In an embodiment, each of the objects described above, and other objects described herein, are generated from import operation(s) of data from various sources, such as an insurer's databases, a provider's health care records, pharmacy records, government records, and other public records. The import operation may be repeated periodically or on occasions to update the objects and/or add new objects. The import operation may involve various ETL operations that normalize the source data to fit data models such as described herein.

In an embodiment, some or all of the objects described herein are not necessarily stored in any permanent repository, but are rather generated from the source data “on demand” for the purpose of the various analyses described herein.

4.1. Logical Object Types

In an embodiment, a data object is a logical data structure that comprising values for various defined fields. A data object may be stored in a variety of underlying structure(s), such as a file, portions of one or more files, one or more XML elements, a database table row, a group of related database table row(s), and so forth. An application will read the underlying structure(s), and interpret the underlying structure(s) as the data object. The data object is then processed using various steps and algorithms such as described herein.

In one embodiment, the modeled object types conceptually include, without limitation: claim objects, such as medical physician claims, medical outpatient claims, medical inpatient claims, and pharmacy claims; patient objects; provider/prescriber objects; prescription objects; pharmacy objects; and fraud objects. Many variations on these combinations of objects are possible.

4.2. Sources

In an embodiment, some or all of the health care data objects are generated from source data hosted by a variety of sources. Example sources include provider or insurer sources such as: a claims processing database; a policy administration database, a provider network database, a membership/eligibility database, a claim account database, a pharmacy benefit database, a lab utilization gateway database, pharmacy claims database, an authentication call list, a tip-off hotline database, and a billing/accounts receivable database. Example sources further include government or public data repositories such as public health records, repositories of USPS zip codes, National Drug Codes, Logical Observation Identifiers Names and Codes, and/or National Provider Identifiers, an OIG exclusion list, and a List of Excluded Individuals/Entities. Of course, many other sources of data are also possible.

4.3. Databases

In an embodiment, data from the various data sources are passed through an ETL layer to form a set of databases. For example, the databases may include: Product, Organization, Geography, Customer, Member, Provider, Claim Statistics, Claim Aggregation, Claim Financial, Pharmacy Claims, Lab Results, and Revenue. The databases may store the various data objects described herein. The data objects may instead be arranged in a variety of other configurations.

4.4. Example Ontology

In an embodiment, an ontology for preventing health care fraud comprises the some or all of the following data object types: Claim objects, Drug objects, Member objects, Pharmacy objects, Plan Benefit objects, Prescriber objects, and Provider objects.

Each claim object represents a health care claim, which is a request for reimbursement from an insurer for health care expenses. There may be multiple types of claim objects, including claims objects for prescriptions, claim objects for laboratory tests, claim objects for medical procedures, and claim objects for other types of services. In an embodiment, a claim object comprises, among other elements, values for one or more the following types of attributes: unique system identifier(s), associated member identifier, allowed amount, claim status (paid, rejected, or reversed), date submitted, covered Medicare Plan D amount, date of service, estimated number of days prescription will last, paid dispensing fee, prescribed drug identifier, ingredient cost paid, mail order identifier, non covered plan paid amount, number of authorized refills, other payer amount, member plan type, amount paid by patient, deductible amount, pharmacy system identifier, prescriber system identifier, prescription written date, quantity dispensed, prescription claim number, service fee (the contractually agreed upon fee for services rendered), total amount billed by processor. Different fields may be specific to different types of providers or claims.

Each drug object represents a specific drug. In an embodiment, a drug object comprises, among other elements, values for one or more the following types of attributes: unique system identifier(s), American Hospital Formulary Service Therapeutic Class Code, generic status indicator (brand name or generic), drug name trademark status (trademarked, branded generic, or generic), dosage form, DEA class code, generic class name, over-the-counter indicator, drug strength, generic code number, generic code sequence, generic product index, maintenance drug code, product identifier qualifier, product service identifier, unit of measure, National Drug Code, and so forth.

Each member object represents a specific member of a health care plan. There may be multiple collections of members for different insurers and/or types of plans, and each collection may have a different structure. In an embodiment, a member object comprises, among other elements, values for one or more the following types of attributes: one or more unique system identifiers, maximum service month, the number of months enrolled in each particular year covered by the data (e.g. a different field for 2007, 2008, and so forth), first name, last name, gender, date of birth, address, city, state, zip code, county, telephone, social security number, additional address and other contact fields for different types of contact information (e.g. work, temporary, emergency, etc.), a plan benefit system identifier, an enrollment source system, and so forth.

In an embodiment, a member object may further include or be associated with tracking data that log changes to values for the above attributes over time. For example, a separate Member Detail object may exist, values for the above attributes for each month or year the member was covered by a plan. Each Member Detail object may include a month and/or year attribute and a member identifier to tie it back to its associated Member object.

Each pharmacy object represents a specific pharmacy. In an embodiment, a pharmacy object comprises, among other elements, values for one or more the following types of attributes: unique system identifier(s), pharmacy dispenser class (independent, chain, clinic, or franchise, government, alternate), pharmacy dispenser type (community/retail, long term, mail order, home infusion therapy, non-pharmacy, Indian health service, Department of Veterans Affairs, institutional, managed care, medical equipment supplier, clinic, specialty, nuclear, military/coast guard, compounding), affiliate code, service provider identifier, service provider identifier qualifier, and so forth.

Each plan benefit object represents a specific plan benefit. In an embodiment, a plan benefit object comprises, among other elements, values for one or more the following types of attributes: unique system identifier(s), contract number, provider identifier, start date, end date, package key, and so forth.

Each prescriber object represents a specific prescriber of drugs. In an embodiment, a plan benefit object comprises, among other elements, values for one or more the following types of attributes: unique system identifier(s), first name, last name, prescriber identifier(s), prescriber identifier qualifier(s) (e.g. not specified, NPI, Medicaid, UPIN, NCPDP ID, State License Number, Federal Tac ID, DEA, or State Issued), specialty code, and so forth. Prescriber objects and provider objects may in some cases represent or be associated with a same real world entity, but prescriber objects reflect data from a different source than provider objects. In some embodiments attributes from prescriber objects and provider objects may be combined into a single object. In other embodiments, the two objects are logically separate, but can be correlated together if they do in fact represent the same entity.

Each provider object represents a specific provider of health care services. In an embodiment, a provider object comprises, among other elements, values for one or more the following types of attributes: medical provider identification number (both text and numeric), provider type (medical professional, healthcare organization), provider status (active contract or no activate contract), various contract line indicators, one or more process exception hold effective dates, one or more process exception type codes, a date that the medical provider identification number was created, a date the provider record became inactive, an organization type code to indicate provided services or specialties, a Medicare identifier, provider medical degree, provider primary specialty, last name, first name, middle initial, name suffix, middle name, gender, social security number, federal tax identifier, date of birth, graduation date, medical school, credential status code, credential description, current credential cycle, current credential type (initial, re-credential, hospital-based, delegated, alliance, discontinued, empire initial, excluded from process, terminated), credential indicator, credential organization identifier, credential organization accreditation date, credential organization indicator, universal provider identifier, bill type (HCFA, UB92, UB04, composite), provider information source, provider claims classifier, email, last update type, address, and so forth.

Additional data objects that may be in a health care ontology are set forth in the attached appendix.

4.5. Metrics

Various example metrics for automatically identifying, prioritizing, and/or investigating leads are described below.

Metrics related to member objects may include, without limitation, one or more of: an average and/or standard deviation of Schedule 2 prescriptions per month; a count of drug abuse diagnoses; a count, average, and/or standard deviation of ER visits per year; a count of distinct providers that have written prescriptions for the member; a count of distinct pharmacies that have filled prescriptions for the member; a sum amount paid by an insurer on behalf of the member; an average and/or standard deviation amount paid per month; a sum number of pills dispensed per month; an average days between prescriptions; an average and/or standard deviation prescriptions per month for the member; an average and/or standard deviation for member medical claims per month; a count of total Schedule 2 prescriptions; a count of total Schedule 3 prescriptions; a count of total prescriptions; an average and/or standard deviation for net amount paid per diagnosis category; a count of durable medical equipment claims; a count of methadone overdoses; a count of opiate poisoning; a methadone dependence indicator; and/or a sum DME Net Amount paid.

Metrics related to provider objects may include, without limitation, one or more of: an average and/or sum total billed by provider; a sum net amount paid to the provider; an average and/or standard deviation net amount paid per month; a standard deviation for net amount paid per month by specialty; a standard deviation for net amount paid per month by specialty by geography, an average prescription pill quantity; an average prescription number of refills; a count of prescription claims not paid; a count of prescription claims; a count of medical claims; an average and/or standard deviation for prescription claims per patient; an average and/or standard deviation for medical claims per patient; a percentage of Schedule 2 drugs; a percentage of Schedule 3 drugs; a percentage of Schedule 2 drugs by specialty; a percentage of Schedule 3 drugs by specialty; a count of distinct patients of the provider; a count of distinct pharmacies to which patients of the provider are sent; a standard deviation of distinct diagnoses made by the provider by specialty; a count of distinct procedures performed by the provider; a count of clinic ownerships; a standard deviation for net amount paid to the provider by diagnosis; a count of durable medical equipment prescriptions made; a percentage of in-network claims attributed to the provider; and/or an estimated total days in business.

Metrics related to provider objects may further include, without limitation, one or more of: average claims per day; average net amount paid per claim; average net amount paid per month; average patient count; average pharmacy count; distinct count of diagnoses; a histogram of diagnoses; distinct count of procedures; and/or a histogram of procedures.

Metrics related to pharmacy objects may include, without limitation, one or more of: average net amount paid by the insurer; maximum and/or average net amount paid per prescriber; count of claims; percentage of filled prescriptions that involved a Schedule 2 category of drugs; percentage of filled prescriptions that involved a Schedule 3 category of drugs; average and/or sum dispensing fee; days in business, percentage of filled prescriptions that involved a brand name drug; a count of distinct drug names in the prescriptions; percentage of filled prescriptions that involved a high reimbursement drug; percentage of filled prescriptions that involved a drug of potential abuse; a percentage of claims for refills; average and/or standard deviation distance traveled by customers to the pharmacy; a count of co-located pharmacies; percentage of filled prescriptions that involved small refills; percentage of claims that were reversed; a count of claims not paid; average billed per patient; average billed per prescriber; average claims per patient; average claims per prescriber.

Metrics related to diagnosis objects may include, without limitation, one or more of: a histogram of CPT-4, ICD-9, ICD-10 or HCPCS procedures; a histogram of co-occurring diagnoses; average net amount paid per year per patient; average total net amount paid per patient; a histogram of drug names prescribed; an indicator of drug abuse; and/or an indicator of drug-seeking behavior.

Metrics related to procedure objects may include, without limitation, one or more of: a histogram of diagnoses; a histogram of co-occurring procedures on the same date per patient; and a total, average, minimum, and/or maximum procedure count per patient per diagnosis.

Metrics related to drug objects may include, without limitation, one or more of: maximum drug quantity per patient per year; and/or minimum, maximum, and/or average net amount paid.

Metrics related to prescription claim objects may include, without limitation, one or more of: distance traveled to pharmacy; distance traveled to prescriber; an indicator of whether the prescription is for a drug of abuse; a standard deviation of net amount paid; an indicator of whether the prescribed patient's gender is appropriate to the prescription; an indicator of whether the prescription claim is for an expensive branded drug; and/or an indicator of whether the prescription claim is for a Schedule 2 commonly abused drug.

Metrics related to medical claim objects may include, without limitation, one or more of: distance traveled to physician; an indicator of whether the claim is indicative of drug abuse; and/or a standard deviation of net amount paid per procedure.

In an embodiment, various triggers may be generated based on the above metrics. The triggers are monitored functions of one or more of the metrics. When a monitored function has a value that is within a particular range, the trigger identifies one or more lead objects that are associated with the one or more metrics.

For example, in an embodiment, triggers may include members visiting three of more independent pharmacies in a day, members obtaining prescriptions in three of more states within a month, or members receiving multiple and subsequent home rental medical equipment. Each of these triggers would produce a member lead object. Another example trigger is multiple new patient office visits for the same patient in a three year period. This trigger would produce a member lead object.

An additional example of a trigger is a Top Pharmacies by Drugs Commonly Abused trigger. For each month, this trigger lists the pharmacy that has dispensed the most amount of one of the commonly abused drugs. An additional example of a trigger is a Top Patients Receiving Drugs Commonly Abused trigger. For each month, this trigger lists the patient receiving the most amount of one of the commonly abused drugs. An additional example of a trigger is a Top Prescribers of Drugs Commonly Abused trigger. This trigger lists the providers who have prescribed the most amount of one of the most commonly abused drugs. An additional example of a trigger is a Mailbox Matching trigger. For each region of interest (as denoted by a City and State), this trigger lists providers who have a practice address that matches the location of a UPS drop box. An additional example of a trigger is a Frequent NPIs trigger. For each region of interest (as denoted by a City and State), this trigger lists provider locations receiving multiple NPIs in a short time frame.

### 5.0. Example Interfaces

FIG. 1 illustrates an example graph of nodes that represent data objects such as described herein, presented on a display 112. The graph is merely an example and may include other types of nodes not shown. The graph was generated based on nodes that are related to lead objects that represent member(s) and/or suspect doctor(s). As shown, the graph includes nodes X, Y, and Z representing member(s) 100 of a health plan who have all received subscriptions (“scripts”) from multiple doctors, B and C, that may have been criminally charged for drug-related offenses. The nodes representing members 100 are connected via edge(s) 101 to node(s) A-G representing doctor(s) and may be connected via edge(s) 101 to node(s) representing criminal event(s) 104 or other types of event(s), and/or to node(s) representing organization(s) 106.

The edges between member nodes and doctor nodes or the node(s) representing organization(s) 106 may represent prescriptions written by the doctors themselves or by anonymous doctors at the organizations. Information about the prescriptions may appear in pharmacy claims in the health plan (for example, claims for reimbursement of expenses for pharmaceuticals). Edges may also represent other documents, objects, relationships, or shared characteristics between the member nodes and the doctor nodes 102 or organization nodes 106. The edges may or may not be graphically labeled with information about what document, object, relationship, or share characteristic connects the nodes, and the edges themselves or the edge labels 108 may be configurable to represent different documents, objects, relationships, or shared characteristics between nodes at the endpoint of the edges.

In an embodiment not illustrated, the different edges may have different thicknesses based on the strength of the association between nodes at the endpoints of the edges. For example, nodes with several items relating them to each other may have thick edges, and nodes with only one or a few items relating them to each other may have thin edges.

Edges and/or nodes may also be color-coded to convey information about the edge or node. For example, doctors that have been charged in criminal events may be colored red, and doctors that have not been charged may be colored in blue or green. In another example, edges that reflect suspect prescriptions may be colored red, and edges that reflect regular prescriptions may be colored in blue or green. The shade of the edge may be redder, bluer, or greener based on how many suspect prescriptions and/or regular prescriptions are represented by the edge. The color coding of nodes and edges is user-configurable and may be customized such that the colors represent different properties.

As shown, doctor A wrote a prescription for member X; doctors B and C wrote prescriptions for members X, Y, and Z; doctor D wrote prescriptions for members X and Y; doctor G wrote a prescription for member Z; an anonymous doctor for organization J wrote a prescription for member Y; and anonymous doctor(s) for organization K wrote prescriptions for members X and Y. These prescriptions may have been written at different times and for different medications.

As shown, at least the prescription written by a doctor at organization K is a “suspect script.” Suspect prescriptions may include prescriptions that are written for drugs that are commonly abused, drugs that can be used for making illegal drugs, or drugs that have otherwise been identified as drugs of interest. Suspect prescriptions may also include prescriptions that have been flagged as unusual (for example, a drug typically for females is prescribed to a male) or identified for investigation by an investigative agency, such as a law enforcement agency. Also as shown, at least the prescription written by doctor G is a regular script. Regular prescriptions may be any prescriptions that are not suspect. In other examples, the edge labels 108 identify different types of suspect drugs or identify the prescriptions as regular prescriptions.

In the graph, doctors C and D belong to organization J; doctors E and F belong to organization K; and doctor G belongs to organization G. In the example, doctor F is shown, via an edge label 108, to be an owner of organization K.

Also as shown in the graph, criminal event H is associated with doctor B, and criminal event I is associated with doctor C. For example, doctors B and C may have been arrested at different times for drug-related charges. Although the edges to nodes C and D are not labeled in the figure, some of these edges may have been labeled as suspect prescriptions.

The graph may be automatically generated by a combination of hardware and/or software, such as stored instructions running on computing devices. The graph may be stored on a storage device, sent over a network, and/or displayed on a display, such as a display on a mobile electronic device, a laptop, or a desktop computer.

An analyst viewing the graph of nodes in FIG. 1 may see that a suspect prescription has been written by organization K to member Y, and a potentially suspect prescription has been written to member X. Members X and Y may also have received potentially suspect prescriptions from doctors B and C, who were criminally charged. In light of these relationships brought to light by the graph, doctor F, who owns organization K, may be the subject of a further investigation even though doctor F may not be known to have personally written any prescriptions for members X, Y, or Z. In particular, doctor F may be questioned about who wrote the suspect prescription for member Y.

The analyst may also or alternatively analyze the graph to determine that doctor G may be removed from the graph. Although doctor G wrote a prescription for member Z, who also received potentially suspect prescriptions from doctors B and C, the prescription from doctor G was a regular prescription that would not normally raise a concern. Member Z may also be removed from the graph if the edges between member Z and doctors B and C were not for suspect prescriptions.

In another embodiment, a rule-based process running on a machine may highlight nodes that are likely to be suspect or interesting and/or nodes that are likely to be non-suspect or not interesting. For example, the rule-based process may mark as interesting nodes with many direct interesting connections and/or many direct connections to other interesting nodes, and the rule-based process may mark as not interesting nodes with few direct interesting connections and/or few direct connections to other interesting nodes. The number of interesting connections and/or connections to other interesting nodes may or may not be relative to a total number of connections or other connected nodes.

FIG. 2 illustrates an example timeline 200 for displaying, on display 212, information such as the information from the graph in FIG. 1 in a manner that highlights when events occurred. For example, the different bars on the timeline may represent numbers of regular prescriptions, suspect prescriptions, and/or arrests that occurred in a period covered by the timeline. As illustrated, timeline 200 includes dates 202 along the bottom, spanning in the example from the year 2000 to the year 2010. The timeline 200 also includes numbers of items 204 along the side, indicating that up to 3 items occurred in a given period of time or on a given date covered by the individual bars in timeline 200.

Timeline 200 may also include a legend 206, which displays information about how to interpret the bars or other graphical indicators on the timeline. For example, the bars may be color-coded, and the legend may indicate which bars correspond to which events. As illustrated, bars having color A, such as green, correspond to regular prescriptions, bars having color B, such as yellow, correspond to suspect prescriptions, and bars having color C, such as red, correspond to arrests.

Timeline 200 may also include labels of summaries of timeline sections 208, such as “suspect prescriptions from doctor B” and “suspect prescriptions from doctor C,” and labels of significant events 210, such as “doctor B arrested” and “doctor C arrested.” The labels 208 and 210 may be user-configurable. For example, a user may elect, via a graphical interface, to highlight period(s) on the timeline where doctor B wrote suspect prescriptions and/or period(s) on the timeline where doctor C wrote suspect prescriptions. As another example, a user may elect, via the graphical interface, to highlight periods on the timeline where doctors B and C were arrested.

The timeline 200 may be automatically generated by a combination of hardware and/or software, such as stored instructions running on computing devices. The graph may be stored on a storage device, sent over a network, and/or displayed on a display, such as a display on a mobile electronic device, a laptop, or a desktop computer.

FIG. 3 shows an example composite representation 330 that includes graph 310 and timeline 320 that are concurrently displayed. As shown, graph 310 identifies member(s) 300, doctor(s) 302, event(s) 304, and organization(s) 306. For example, these different entities may be represented by nodes in the graph. Entities that are associated with each other based on stored information may be connected via edge(s) 301. Timeline 320 includes bars arranged in time order, labels 322, and legend 324.

Graph 310 and timeline 320 may represent the same data. For example, the prescriptions represented in timeline 320 may represent edges in graph 310. Removing edges and/or nodes from graph 310 may cause removal of corresponding edges and/or nodes represented in timeline 320. Similarly, removing edges and/or nodes from timeline 320 may cause removal of corresponding edges and/or nodes represented in graph 310. Graph 310 and timeline 320 may also include similar color-coded mappings. For example, nodes or edges in graph 310 may be colored based on certain criteria, and the same criteria may be used to color bars in timeline 320.

FIG. 4 illustrates an example process for graphically arranging and utilizing information about member(s) that are related to suspect doctor(s). The process may be performed by a combination of hardware and/or software, such as stored instructions running on computing devices. The stored instructions may be part of a special-purpose module for graphically arranging and utilizing information about member(s) that are related to suspect doctor(s).

In step 400 of FIG. 4, the module determines member(s) related to a set of suspect doctor(s). For example, the doctors may be suspected for or may have been charged with or convicted for drug-related offenses. In step 402, the module graphically arranges information related to determined member(s), optionally after filtering the information based on certain criteria. Step 402 may include sub-step 402A, where the module generates a graph of the member(s), any doctor(s) who wrote script(s) to the member(s), any criminal event(s) or other event(s) related to those doctor(s) or member(s), and/or any medical organization related to the doctor(s) or member(s). The generated graph also includes connections between these entities to reflect associations between the entities. Step 402 may also include sub-step 402B, where the module generates a timeline that distinguishes general script(s), suspect script(s), and/or arrest(s) over time, optionally including label(s) of significant event(s) or a summary or summaries of prescriptions represented in the timeline.

Once the graph and/or timeline have been generated by the module, the module may further support analysis of node(s) or edge(s) in the graph or period(s) in the timeline. In step 404A, the module, via a user interface, receives a selection of node(s) in the graph. In response to step 404A, in step 406A, the module stores an indication that the selected node(s) are marked for further analysis and/or display additional information about the selected node(s). For example, clicking on or touching a node on the display may trigger display of additional details about the node that were not previously displayed.

In step 404B, the module, via a user interface, receives a selection of a period of time in the timeline. In response to step 404B, in step 406B, the module may filter the graph to exclude node(s) that were in the graph due to script(s) and/or event(s) that are outside of the selected period in the timeline. In one example, the selection that triggers filtering may select multiple non-adjacent periods on the timeline, and, in response, items between these adjacent periods may be filtered from the graph.

FIG. 5 illustrates an example process for graphically arranging and utilizing information about doctor(s) that are related to suspect member(s). The process may be performed by a combination of hardware and/or software, such as stored instructions running on computing devices. The stored instructions may be part of a special-purpose module for graphically arranging and utilizing information about member(s) that are related to suspect doctor(s).

In step 500 of FIG. 5, the module determines doctor(s) related to a set of suspect member(s). For example, the members may be suspected for or may have been charged with or convicted for drug-related offenses. In step 502, the module graphically arranges information related to determined member(s), optionally after filtering the information based on certain criteria. Step 502 may include sub-step 502A, where the module generates a graph of the doctor(s), any member(s) to whom the doctor(s) wrote script(s), any criminal event(s) or other event(s) related to those doctor(s) or member(s), and/or any medical organization related to the doctor(s) or member(s). The generated graph also includes connections between these entities to reflect associations between the entities. Step 502 may also include sub-step 502B, where the module generates a timeline that distinguishes general script(s), suspect script(s), and/or arrest(s) over time, optionally including label(s) of significant event(s) or a summary or summaries of prescriptions represented in the timeline.

The process of FIG. 5 may analyze and use the graph and/or timeline in ways that are similar to those mentioned in FIG. 4. The graphs and timelines generated according to the processes herein may generally be used and analyzed to detect potentially fraudulent activities by member(s) or doctor(s) for the purpose of cutting health care expenses that are caused by the fraudulent activities. Analysis of the graphs and timeline may be partially based on user input to a user interface and/or automated statistical, relational, and correlative processing that may be performed automatically without user input.

FIG. 1, FIG. 2, FIG. 3, FIG. 4, FIG. 5 illustrate one example of a graph and interface useful for practicing the techniques described herein. Other graphs and interfaces may include fewer or additional elements in varying arrangements in other embodiments. For example, FIG. 8 illustrates another example graph 800 in which a node 810 representing a particular patient object is connected by various edges 811-815 to pharmacy nodes 831-835 representing pharmacy objects, according to an embodiment. The edges 811-815 by which the patient node 810 is connected to the pharmacy nodes 831-835 represent various relationships formed from various events, such as “two pharmacy claims.” These relationships are described in labels associated with the edges 811-815. The pharmacy nodes 831-835 are color-coded by whether they are associated with instances of fraud. Certain pharmacy nodes 831-835 are further linked to owner nodes 862-864 representing owner objects and/or pharmacist nodes 865-866 representing pharmacist objects. As indicated by the labels associated with the corresponding edges 841-846, these links were established by phone record relationships, employer/employee relationships, and/or address relationships. Various owner nodes 862-864 and pharmacist nodes 865-866 are, in turn, related to other pharmacist nodes 867-869, as indicated by edges 852-855 representing by possible familial relationships or possible identity relationships. Various pharmacist nodes 865 and 869 are related by arrest event relationships 881 and 882 to specific fraud nodes representing fraud event objects 871 and 872. Another pharmacy node 836, not immediately related to the patient node, has been identified as related to owner node 861, as indicate by edge 851.

In an embodiment, the graph of FIG. 8 is not a comprehensive network of entities or relationships, but has rather been filtered for entities and/or relationships of likely interest to an analyst, using techniques such as described herein. A zoomed out graph control 890 and zoom bar 895 permit zooming in and out of the graph.

This disclosure sometimes describes graphical interface features in terms of represented items themselves, as opposed to the graphical representations of those items. As is common when describing graphical interfaces, literal descriptions of a graphical interface comprising non-graphical interface components should be interpreted as descriptions of the graphical interface comprising graphical representations of those components. For example, the description may describe a step of “selecting a node” when in fact what is selected is a representation of a node in the workspace.

### 6.0. Example Use Cases

The following examples illustrate how a user may utilize the techniques described herein to simplify various objectives related to identifying and/or investigating health care fraud. The examples are given for illustrative purposes only, and not by way of limitation as to the type of objectives to which the techniques described herein may be applied.

One example use case involves identifying expensive facilities as possible leads. An analysis module generates a histogram of cost over everything, by facility. Then, the module filters by diagnoses, and links by an ICD9 code. The module shows an aggregated metric for the diagnosis, such as average/20/80 percentiles of cost per facility. The module creates a dynamic group of expensive facilities. The module compares histogram costs and readmission rates to identify suspect facilities.

Another example use case involves investigating a particular provider. An investigative analyst receives a workflow ticket indicating that the particular provider is a lead. The analyst instructs a graph-based interface, such as described herein, to show a graph of linked entities. The analyst filters the graph to show only providers related to the particular provider. The analyst creates new workflow tickets identifying these providers as leads. The analyst returns to the unfiltered graph of the particular member. The analyst instructs the interface to show pharmaceutical claims related to the particular provider, linked to the members making those claims. The analyst identifies those members as being at risk for fraud, and may or may not create workflow tickets for them. The analyst instructs the interface to expand the graph to include other providers and pharmacies that the members are connected to. The analyst filters the pharmacies to include only the highest-ranked pharmacies for one or more metrics indicative of a risk factor, such as volume of prescriptions for certain drugs. The analyst then uses the graph to identify members who visit those pharmacies and get high amounts of oxycodone prescriptions. The investigation has thus identified a list of other doctors to investigate, a list of “at-risk” members, and a list of pharmacies to avoid or to pay closer attention to.

### 7.0. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method comprising:
generating provider objects that describe health care providers;
generating patient objects that describe health care recipients;
generating health care event objects, the health care event objects including at least objects of a prescription event type, objects of a medical claim event type, and objects of a diagnosis event type;
generating fraud objects representing known instances of health care fraud;
storing the provider objects, patient objects, health care event objects, and fraud objects in a digital computer-readable storage medium;
correlating the health care event objects to the provider objects and the patient objects;
receiving input specifying a particular object, wherein the particular object is one of a particular provider object or a particular patient object;
based on the correlating, identifying a network comprising one or more provider objects and one or more patient objects that are associated with the particular object;
generating a graph of the network, the graph comprising linked nodes, the linked nodes including one or more patient nodes that represent the one or more patient objects and one or more provider nodes that represent the one or more provider objects;
linking a particular provider node or a particular patient node to a fraud node within the graph, the fraud node representing a particular fraud object;
wherein the method is performed by one or more computing devices.

2. The method of claim 1, wherein generating the health care event objects comprises generating a separate health care event object from each log entry in one or more logs collected from one or more of: a provider data source, an insurer data source or a pharmacy data source.

3. The method of claim 2, further comprising:
generating fraud objects representing known instances of health care fraud;
linking a particular provider node or a particular patient node to a fraud node within the graph, the fraud node representing a particular fraud object.

4. The method of claim 2, wherein the health care event objects include at least objects of a prescription event type, objects of a medical claim event type, and objects of a diagnosis event type.

5. The method of claim 1, further comprising:
generating pharmacy objects that describe pharmacies;
wherein the linked nodes include one or more pharmacy nodes that represent one or more pharmacy objects.

6. The method of claim 1, further comprising:
correlating multiple objects of different types to a single entity, the multiple objects comprising one or more of the provider objects or the patient objects; and
representing the multiple objects within the graph as one of: a single node representing a logical object that corresponds to a merger of the multiple objects, or as multiple nodes linked to each other by one or more relationships.

7. The method of claim 1,
wherein the correlating further comprises deriving relationship constructs based on the health care event objects;
wherein the relationship constructs define links between the provider objects and the patient objects.

8. The method of claim 1,
wherein the correlating further comprises deriving relationship constructs based on the provider objects;
wherein the relationship constructs define links between the provider objects and the patient objects;
wherein the graph comprises one or more edges that depict links between particular linked nodes, the edges representing one or more of the relationship constructs.

9. The method of claim 1,
wherein the correlating further comprises deriving relationship constructs based on the health care event objects;
wherein the relationship constructs define links between the provider objects and the patient objects;
wherein the graph comprises one or more edges that depict particular links between particular linked nodes, the one or more edges representing one or more of the relationships;
wherein the one or more edges comprise a first edge that graphically represents a first relationship type and a second edge that graphically represents a second relationship type.

10. The method of claim 1,
wherein the correlating further comprises deriving relationship constructs based on the provider objects;
wherein the relationship constructs define links between the provider objects and the patient objects;
wherein the graph comprises one or more edges that depict particular links between particular linked nodes, the one or more edges representing one or more of the relationship constructs;
wherein the one or more edges graphically depict a summary of particular health care event objects from which the one or more of the relationship constructs were derived.

11. The method of claim 1, further comprising:
computing values of metrics associated with the provider objects and metrics associated with the patient objects based at least in part on the correlating;
depicting, within the graph, one or both of the linked nodes or edges linked the linked nodes differently based on the computed values.

12. The method of claim 1, further comprising:
computing values of metrics associated with the provider objects and metrics associated with the patient objects based at least in part on the correlating;
generating a visualization of the values;
wherein the particular object is selected in part based on a selection of a particular value, calculated in association with the particular object, from the visualization.

13. The method of claim 1, further comprising:
computing values of metrics associated with the provider objects and metrics associated with the patient objects based at least in part on the correlating;
comparing the values to defined triggers that define thresholds for unusual values;
selecting the particular object at least partly responsive to the particular object being associated with a particular metric value that has an unusual value according to a particular defined trigger.

14. The method of claim 1, wherein the network comprises an object that represents a particular practitioner, objects that represent patients who have had prescriptions written by the particular practitioner, and objects that represent other practitioners that those patients have visited.

15. The method of claim 1, wherein the network comprises an object that represents a pharmacy customer, objects that represent pharmacies visited by that pharmacy customer, objects that represent pharmacists employed at the pharmacies, and objects that represent instances of fraud associated with the pharmacists or pharmacies.

16. The method of claim 1, further comprising:
computing values of metrics associated with the provider objects and metrics associated with the patient objects based at least in part on the correlating;
determining a size of the network based at least in part on the metric values.

17. The method of claim 2,
wherein the presentation includes one or more of: a list or timeline of data from health care event objects correlated to the first object, aggregated statistics calculated in association with the first object, demographic information associated with the first object, or a map depicting locations and/or health care events related to the particular object.

18. The method of claim 2, further comprising:
embedding, within the interface, a second control for selecting a particular edge between particular linked nodes;
generating a presentation of data associated with one or more particular relationships that the particular edge represents responsive to selection of the second control, the one or more particular relationships derived from particular health care event objects, the presentation including one or more of a list of the particular health care events or a map of the particular health care events.

19. The method of claim 2, further comprising:
embedding, within the interface, a second control for selecting the particular linked node;
wherein the method further comprises: responsive to selection of the second control, flagging the first object associated with the particular linked node for subsequent investigation and generating a workflow ticket identifying the first object as a lead.

20. The method of claim 1, further comprising:
computing values of metrics associated with the provider objects and metrics associated with the patient objects based at least in part on the correlating;
wherein the particular object is selected based in part on a metric value associated with the particular object that indicates one or more of: a doctor writing significantly more prescriptions than normal; a sudden increase in prescriptions filled by a patient who was not previously filling many prescriptions, a patient receiving a significant amount of emergency room visits in a specific time period; a patient receiving prescriptions from more than a certain number of providers within a certain time period.

21. A method comprising:
generating provider objects that describe health care providers;
generating patient objects that describe health care recipients;
generating health care event objects that describe one or more of: health care claims, prescriptions, medical procedures, or diagnoses;
storing the provider objects, patient objects, and health care event objects in a digital computer-readable storage medium;
correlating the health care event objects to the provider objects and the patient objects;
receiving input specifying a particular object, wherein the particular object is one of a particular provider object or a particular patient object;
based on the correlating, identifying a network comprising one or more provider objects and one or more patient objects that are associated with the particular object;
generating a graph of the network, the graph comprising linked nodes, the linked nodes including one or more patient nodes that represent the one or more patient objects and one or more provider nodes that represent the one or more provider objects;
presenting the graph as part of an interactive interface for investigating health care data, the interface embedding a first control for selecting at least a particular linked node;
responsive to selection of the first control, generating a presentation comprising data associated with a first object that the particular linked node represents;
wherein the method is performed by one or more computing devices.

22. The method of claim 1, further comprising:
performing one or more import operations on data from a plurality of sources of health care data, the plurality of sources including a provider data source, an insurer data source, and a pharmacy data source;
wherein generating the provider objects, patient objects, and health care event objects occurs as part of the one or more import operations.

23. The method of claim 1, further comprising:
automatically parsing named entities from electronic news articles and/or indictments concerning instances of fraud;
generating at least some of the fraud objects based on the parsing.

24. The method of claim 1, further comprising correlating the fraud objects to patient objects and/or provider objects.
